(19) United States
(12) Patent Application Publication
(10) Pub. No.: US 2004/0086817 A1
(43) Pub. Date: May 6, 2004

(54) Candle with embedded decorative sculpture

(76) Inventor: Terry Hermanson, New York, NY (US)

Correspondence Address: FITZPATRICK CELLA HARPER & SCINTO, 30 ROCKEFELLER PLAZA, NEW YORK, NY, 10112, US

(21) Appl. No.: 10/287,623

(22) Filed: Nov. 5, 2002

(51) Int. Cl. C11C 5/00

(52) U.S. Cl. 431/289; 431/291; 431/126

(57) ABSTRACT

A candle including at least one sculpture that is partially or completely concealed within the candle. The sculpture or sculptures are partially or completely exposed or revealed as the candle melts and the candle fuel is consumed. The candle may further comprise a container and/or at least one platform. The candle may further comprise a message on its exterior.

### BACKGROUND OF THE INVENTION

1. Field of the Invention

The present invention relates to a candle, and more particularly to a candle comprising at least one, at least partially embedded decorative sculpture.

2. Discussion of Related Art

The fundamental concepts and processes for making candles are well known. However, it is desirable to develop new ways of imparting novel and aesthetically pleasing characteristics to the basic known candle structure. U.S. Pat. No. 6,371,755, for example, discloses a candle in the configuration of a “rolled bun.” U.S. Pat. No. 4,682,947 discloses a candle that, upon burning, forms a filagree pattern. U.S. Pat. No. 4,696,640 discloses a candle that, upon burning, reveals a personalized message. Finally, U.S. Pat. No. 5,879,153 discloses a candle that, upon burning, reveals a non-meltable body corresponding to the shape and configuration of the meltable candle itself.

The present invention further addresses the need to provide new and aesthetically pleasing characteristics to the basic candle structure.

### SUMMARY OF THE INVENTION

The present invention provides for a candle with at least one, at least partially embedded sculpture, that becomes at least partially exposed during the melting process and remains intact after the candle is completely melted and consumed. The sculpture or sculptures are made from a non-meltable material, and are at least partially concealed by the candle material itself before the candle is lit.

In accordance with one aspect, the present invention is directed to a candle comprising a body of fuel having a top region and a base region; at least one wick supported within the body of fuel, the wick having a top portion and a bottom portion, wherein the top portion of the wick projects above the top region of the body of fuel; and at least one sculpture at least partially concealed within the body of fuel. The sculpture or sculptures are at least partially exposed as the fuel is melted and consumed. The candle further comprises means for substantially evenly or selectively melting the body of fuel, and thereby substantially evenly or selectively exposing the sculpture or sculptures. In accordance with this aspect, the means for substantially evenly or selectively melting the body of fuel comprises the positioning of the wick or wicks within the body of fuel. When the wick or wicks are lit, the body of fuel is consumed in such a manner that the top region is melted and consumed substantially evenly or selectively, thereby substantially evenly or selectively, at least partially exposing the sculpture or sculptures.

In accordance with another aspect, the present invention is directed to a candle comprising a body of fuel; at least one wick supported within the body of fuel; and at least one sculpture at least partially concealed within the body of fuel. The sculpture or sculptures are at least partially exposed as the fuel is melted and consumed. The candle further comprises means for substantially evenly or selectively melting the body of fuel, and thereby substantially evenly or selectively exposing the sculpture or sculptures. In accordance with this aspect, the means for substantially evenly or selectively melting the body of fuel comprises the composition of the body of fuel. When the wick or wicks are lit, the body of fuel is consumed in such a manner that the sculpture or sculptures are substantially evenly or selectively, at least partially exposed.

In accordance with another aspect, the present invention is directed to a candle comprising a body of fuel; at least one wick supported within the body of fuel; and at least one sculpture at least partially concealed within the body of fuel. The sculpture or sculptures are at least partially exposed as the fuel is melted and consumed. In accordance with this aspect, the candle further comprises a container, wherein the candle and the at least partially embedded sculpture may fit into the container, and wherein the container may confine the fuel during and after the melting process.

In accordance with another aspect, the present invention is directed to a candle comprising a body of fuel; at least one wick supported within the body of fuel; and at least one sculpture at least partially concealed within the body of fuel. The sculpture or sculptures are at least partially exposed as the fuel is melted and consumed. In accordance with this aspect, the candle further comprises at least one platform, wherein the candle and the at least partially embedded sculpture may be supported by the at least one platform.

An advantage of the present invention is that the at least partially concealed and then exposed sculpture or sculptures provide a new and aesthetically pleasing characteristic to the basic candle structure. Another advantage of the present invention is that the sculpture or sculptures remain intact after the body of fuel is consumed. Another advantage of the present invention is that the container may confine the fuel during and after the melting process, and the at least one platform may allow the candle with embedded sculpture to appear to be floating.

### BRIEF DESCRIPTION OF THE DRAWINGS

The foregoing and other aspects of the present invention will best be appreciated with reference to the detailed description of the invention in conjunction with the accompanying drawings, wherein:

FIG. 1 is a perspective view of a candle with an embedded sculpture, having multiple wicks, before the-candle is lit, in accordance an exemplary embodiment of the present invention.

FIG. 2 is a perspective view of the exemplary embodiment of the candle with an embedded sculpture, having multiple wicks, after the candle fuel has partially melted and been consumed, in accordance with the present invention.

FIG. 3 is a perspective view of another candle having an embedded sculpture, with a single wick, before the candle is lit, in accordance with another exemplary embodiment of the present invention.

FIG. 4 is a perspective view of the exemplary embodiment of the candle having an embedded sculpture, with a single wick, after the candle fuel has partially melted and been consumed, in accordance with the present invention.

FIG. 5 is a perspective view of the exemplary embodiment of the candle having an embedded sculpture, with a single wick, after the candle fuel has almost completely melted and been consumed, in accordance with the present invention.

FIGS. 6A and 6B are perspective views of another exemplary embodiment of the candle with an embedded sculpture, having multiple wicks, and having a container and a platform, in accordance with the present invention.

### DETAILED DESCRIPTION OF PREFERRED EMBODIMENTS

The present invention is directed to a candle with at least one, at least partially embedded sculpture, that becomes at least partially exposed during the melting process, and that remains intact after the candle fuel is completely melted and consumed. The sculpture or sculptures are made from material that does not melt at temperatures reached by the burning candle fuel. The sculpture or sculptures are at least partially concealed by the candle material itself before the candle is lit.

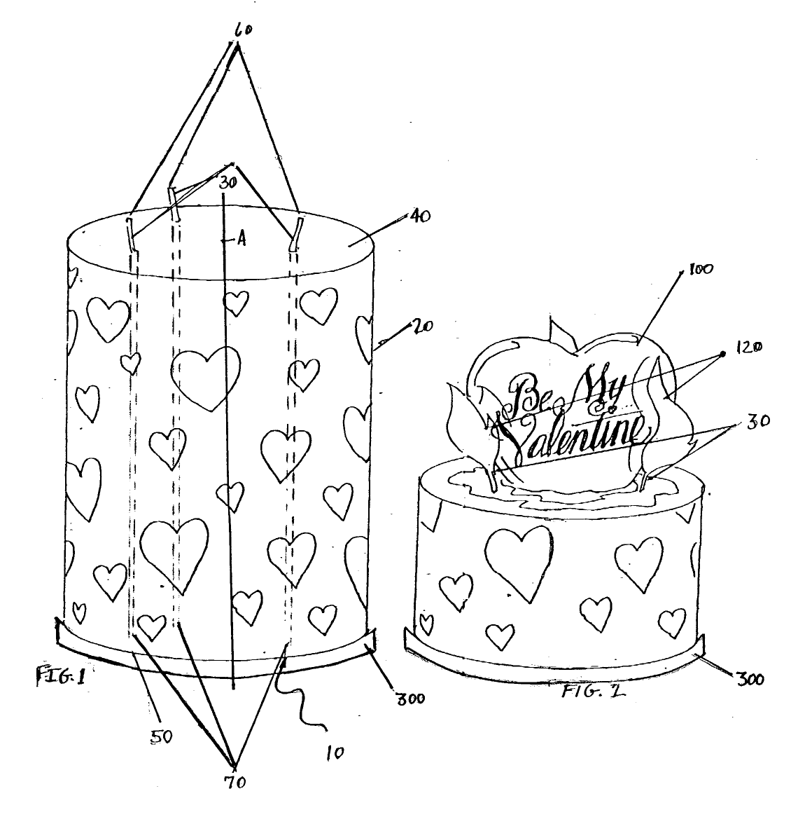

While the present invention may be realized in a number of different forms, for ease of explanation, three exemplary embodiments will be described in detail. Referring to the figures wherein like numerals indicate the same element throughout the views, there is shown in FIG. 1 a candle 10, comprising a body of fuel 20, and at least one wick 30 supported within the body of fuel 20. In this exemplary embodiment, the body of fuel 20 comprises a top region 40 and a base region 50. Each wick 30 comprises a top portion 60 and a bottom portion 70. Each wick top portion 60 projects above the top region 40 of the body of fuel, and each wick bottom portion 50 is embedded within the body of fuel 20, and may be substantially near the body of fuel base region 50, as illustrated in FIG. 1.

As illustrated in FIG. 2, there is at least partially embedded within the body of fuel 20 at least one sculpture 100. The sculpture 100 is exposed or revealed as the body of fuel 20 is consumed, after the wick 30 has been lit and the candle is burning. As illustrated in FIG. 2, there is a flame 120 emanating from the burning wick 30, as the wick 30 burns down and the body of fuel 20 is consumed.

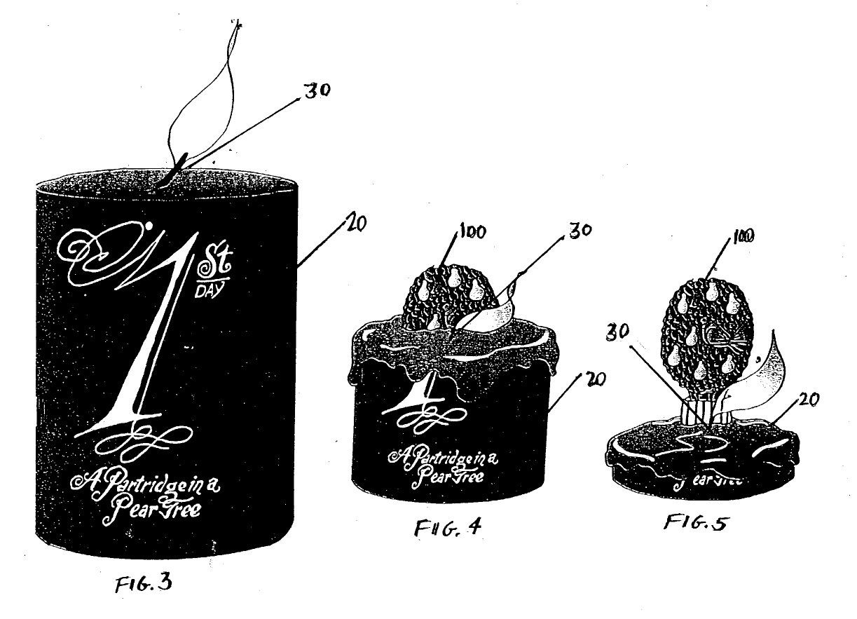

As further illustrated in FIGS. 3, 4 and 5, the burning of the single wick 30, in this exemplary embodiment, has the effect of gradually consuming the body of fuel 20, and gradually revealing the sculpture 100. As illustrated in FIG. 5, ultimately the body of fuel 20 is almost fully consumed, and the sculpture 100 is almost fully revealed, and remains intact after the candle 10 has completely burned down and the candle fuel has been consumed.

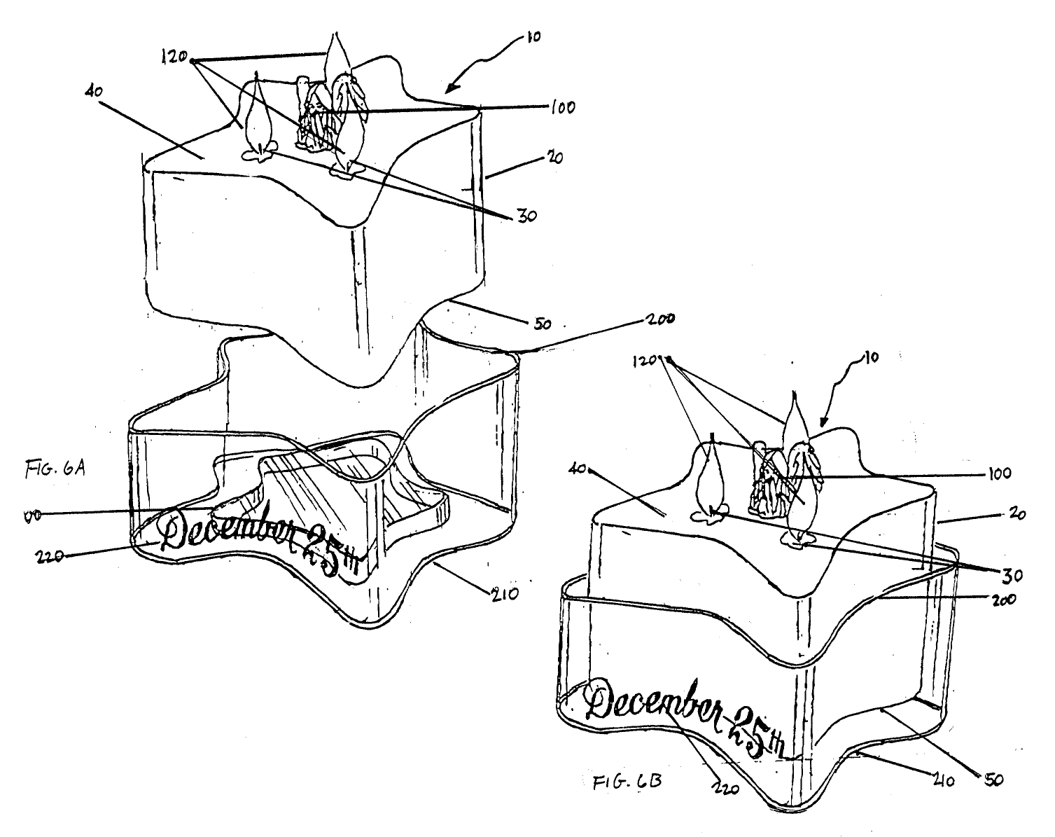

As illustrated in FIGS. 6A and 6B, the candle in this exemplary embodiment may further comprise a container 200 and/or at least one platform 300.

The candle with an embedded sculpture, and the container and platform, are shown separated in FIG. 6A, for ease of illustration, and together or assembled, in FIG. 6B. The container 200 may be larger than the candle 10, and may be of a similar configuration or shape as the candle 10, as illustrated in FIG. 6A, or may be a different shape or configuration. The container 200 may have a base 210. The platform 300 may be placed within the container, substantially on or near the base 210, as illustrated in FIG. 6A, or alternatively the platform may be suspended from or near the side or sides of the container. The platform may be smaller than the candle 10, and may be of a similar shape or configuration as the candle 10, as illustrated in FIG. 6A, or may be of a different shape or configuration. As each wick 30 burns down, the sculpture 100 is at least partially revealed, the body of fuel 20 is consumed, and the container 200 may confine any remaining melted or unmelted fuel. The platform 300 may support the candle 10, and the embedded sculpture 100, as illustrated in FIG. 6B, and the candle may appear to float before and during the melting process. After the melting process is complete, the platform 300 may be concealed by any remaining fuel, and may support the at least partially revealed sculpture 100.

The candle 10 may be made in any suitable configuration, including cylindrical, circular, quadrilateral and polygonal, and in any suitable variation thereof, and is preferably cylindrical, which configuration is also known as a pillar candle or column candle. The candle 10 may comprise any suitable message on the outer surface of the fuel body, and may preferably comprise a written message. As illustrated in FIG. 1, the candle 10 may comprise a recorded text or musical message, which may be delivered by a known sound reproducing means 300, such as a battery-powered device which generates an audible program. The sound reproducing means 300 may be made in any suitable configuration, and may be made from any suitable material, and is preferably made from a material that does not melt when reached by the burning candle fuel. The body of fuel 20 may be made from any suitable material, and is preferably made from wax or paraffin. The body of fuel 20 is preferably solid at room temperature but melts when exposed to the heat of a flame. The fuel 20 may further incorporate any suitable fragrance or scent. The wick 30 may be made from any suitable material, and is preferably made from a combustible fiber.

The sculpture 100 may also be made from any suitable material, and is preferably made from a material such as ceramic or metal that is not degraded at temperatures reached by the burning candle fuel. The sculpture 100 may also be made in any suitable configuration or structure, and the configuration or structure does not need to conform to the configuration or structure of the body of fuel. The sculpture 100 may also be partially or fully concealed by the body of fuel 20.

The means for substantially evenly or selectively melting the body of fuel 20 may be any suitable means, and may preferably result from the positioning of the wick 30 within the body of fuel 20, or from the composition of the body of fuel 20 itself. The first preferred embodiment incorporates three wicks spaced substantially evenly about the sculpture, circumferentially about the vertical axis A of the candle body.

The body of fuel 20 may still further comprise materials that melt at different temperatures, thereby yielding a selective melting result. The container 200 may be made in any suitable configuration, and may be made from any suitable material, such as plastic or glass, and is preferably made from a material that is not degraded by temperatures reached by the burning candle fuel. The container 200 may be made in any suitable color, and is preferably clear. The container 200 may comprise any suitable message on the outer surface of the container, and may preferably comprise a written message. The platform 300 may be made in any suitable configuration, and may be made from any suitable material, such as plastic or glass, and is preferably made from a material that is not degraded by temperatures reached by the burning candle fuel. The platform 300 may be made in any suitable color, and is preferably clear. The platform 300 may comprise any suitable message on the outer surface of the platform, and may preferably comprise a written message. The candle 10 may comprise a container 200 or at least one platform 300, or the combination of a container 200 and at least one platform 300, or may comprise neither element.

Although shown and described are what are believed to be the preferred embodiments of the candle in accordance with the invention, it is apparent that departures from specific designs and methods described and shown will suggest themselves to those skilled in the art and may be used without departing from the spirit and scope of the invention. The present invention is not restricted to the particular constructions described and illustrated, but should be constructed to encompass all modifications that may fall within the scope of the following claims.

That which is claimed is:

1. A candle comprising:
a body of fuel;
at least one wick supported within said body of fuel; and
at least one sculpture, at least partially concealed within said body of fuel, wherein said at least one sculpture is at least partially exposed as said fuel is melted.

2. The candle according to claim 1, wherein said candle has a cylindrical configuration.

3. The candle according to claim 1, further comprising a scent.

4. The candle according to claim 1, further comprising a message on the exterior of said body of fuel.

5. The candle according to claim 4, wherein said message is a written message.

6. The candle according to claim 1, further comprising means for reproducing a recorded message.

7. The candle according to claim 6, wherein said message is a musical message.

8. The candle according to claim 1, wherein said at least one sculpture comprises a material that does not melt at temperatures reached by said fuel when melting.

9. The candle according to claim 1, wherein said candle further comprises means for substantially evenly or selectively melting said body of fuel, and substantially evenly or selectively, at least partially exposing said at least one sculpture.

10. The candle according to claim 9, wherein said means for substantially evenly or selectively melting said body of fuel, and substantially evenly or selectively, at least partially exposing said at least one sculpture comprises the positioning of said at least one wick within said body of fuel.

11. The candle according to claim 9, wherein said means for substantially evenly or selectively melting said body of fuel, and substantially evenly or selectively, at least partially exposing said at least one sculpture comprises the composition of said body of fuel.

12. The candle according to claim 1, comprising at least three wicks.

13. The candle according to claim 1, wherein said body of fuel defines a vertical axis, and wherein said wicks are spaced substantially evenly about said sculpture relative to said vertical axis of said body of fuel.

14. The candle according to claim 1, further comprising a container, wherein said candle fits into said container.

15. The candle according to claim 1 or 14, further comprising at least one platform, wherein said at least one platform supports said candle and said at least one sculpture.

16. A candle comprising:
a body of fuel having a top region and a base region;
at least one wick supported within said body of fuel, said wick having a top portion and a bottom portion, wherein said top portion projects above said top region of said body of fuel; and
at least one sculpture at least partially concealed within said body of fuel, wherein said sculpture is at least partially exposed as said fuel is melted.

17. The candle according to claim 16, wherein said candle has a cylindrical configuration.

18. The candle according to claim 16, further comprising a scent.

19. The candle according to claim 16, further comprising a message on the exterior of said body of fuel.

20. The candle according to claim 19, wherein said message is a written message.

21. The candle according to claim 1, further comprising means for reproducing a recorded message.

22. The candle according to claim 21, wherein said message is a musical message.

23. The candle according to claim 16, wherein said at least one sculpture comprises a material that does not melt at temperatures reached by said fuel when melting.

24. The candle according to claim 16, wherein said candle further comprises means for substantially evenly or selectively melting said body of fuel, and substantially evenly or selectively, at least partially exposing said at least one sculpture.

25. The candle according to claim 24, wherein said means for substantially evenly or selectively melting said body of fuel, and substantially evenly or selectively, at least partially exposing said at least one sculpture comprises the positioning of said at least one wick within said body of fuel.

26. The candle according to claim 24, wherein said means for substantially evenly or selectively melting said body of fuel, and substantially evenly or selectively, at least partially exposing said at least one sculpture comprises the composition of said body of fuel.

27. The candle according to claim 16, comprising at least three wicks.

28. The candle according to claim 16, wherein said body of fuel defines a vertical axis, and wherein said wicks are spaced substantially evenly about said sculpture relative to said vertical axis of said body of fuel.

29. The candle according to claim 16, further comprising a container, wherein said candle fits into said container.

30. The candle according to claim 16 or 29, further comprising at least one platform, wherein said at least one platform supports said candle and said at least one sculpture.

31. For use with a candle, the improvement comprising:
a sculpture at least partially embedded within said candle, wherein said sculpture is at least partially exposed as said candle melts.
